(19) United States
(12) Patent Application Publication
(10) Pub. No.: US 2018/0082138 A1
(43) Pub. Date: Mar. 22, 2018

(54) SEMICONDUCTOR DEVICE

(71) Applicant: KABUSHIKI KAISHA TOSHIBA, Tokyo (JP)

(72) Inventor: Yuichi ITO, Yokohama Kanagawa (JP)

(21) Appl. No.: 15/447,120

(22) Filed: Mar. 2, 2017

(30) Foreign Application Priority Data
Sep. 16, 2016 (JP) 2016-181441

(51) Int. Cl. G06K 9/03; G06K 9/00; G06K 9/64

(52) U.S. Cl. CPC G06K 9/03; G06K 9/64; G06K 9/00986

(57) ABSTRACT

According to one embodiment, a semiconductor device for processing image data of an image includes an image processing circuit comprising circuit elements configured to process the image data and output first image data, a processor configured to process the image data using arithmetic processing software and output second image data, and a comparison unit configured to compare the first image data and the second image data and output a detection signal indicating whether or not the first image data and the second image data match each other.

### CROSS-REFERENCE TO RELATED APPLICATION

This application is based upon and claims the benefit of priority from Japanese Patent Application No. 2016-181441, filed Sep. 16, 2016, the entire contents of which are incorporated herein by reference.

### FIELD

Embodiments described herein relate generally to a semiconductor device that includes an image processing device having a circuit performing image processing on image data.

### BACKGROUND

As a semiconductor device, an image processing device that includes an image processing circuit performing image processing on image data supplied from a camera is known. A mechanism for detecting a failure occurring in the image processing circuit included in the image processing device is needed.

### DESCRIPTION OF THE DRAWINGS

FIG. 1 is a block diagram illustrating the configuration of a semiconductor device including an image processing device according to a first embodiment.

FIG. 2 is a block diagram illustrating a configuration example of an image processing circuit according to the first embodiment.

FIG. 3 is a block diagram illustrating a configuration of a software image processing unit according to the first embodiment.

FIG. 4 is a flowchart illustrating an example of processing by the software image processing unit according to the first embodiment.

FIG. 5 is a diagram illustrating matrix conversion processing for performing a color space conversion as an example of the image processing according to the first embodiment.

FIG. 6 is a diagram illustrating an example of image data output from a camera.

FIG. 7 is a timing chart illustrating an operation of the image processing device according to the first embodiment.

FIG. 8 is a timing chart illustrating an operation of the image processing device according to a second embodiment.

FIG. 9 is a block diagram illustrating a configuration of a semiconductor device including an image processing device according to a third embodiment.

FIG. 10 is a block diagram illustrating a configuration example of an image processing circuit according to the third embodiment.

FIG. 11 is a flowchart illustrating an example of processing by a software image processing unit according to the third embodiment.

FIG. 12 is a timing chart illustrating an operation of a semiconductor device according to the third embodiment.

FIG. 13 is a timing chart illustrating an operation of an image processing device according to a fourth embodiment.

### DETAILED DESCRIPTION

According to exemplary embodiment, there is provided a semiconductor device that can detect a failure in an image processing circuit which performs processing on image data, and has reduced circuit size, power consumption, and failure rate.

In general, according to an embodiment, a semiconductor device for processing image data of an image includes an image processing circuit comprising circuit elements configured to process the image data and output first image data, a processor configured to process the image data using arithmetic processing software and output second image data, and a comparison unit configured to compare the first image data and the second image data and output a detection signal indicating whether or not the first image data and the second image data match each other.

Hereinafter, embodiments will be described with reference to the drawings. In the description below, the same reference symbols will be given to the configuration elements having the same functions and configurations.

### 1. First Embodiment

A semiconductor device including an image processing device according to a first embodiment will be described.

### 1-1. Configuration of the Semiconductor Device

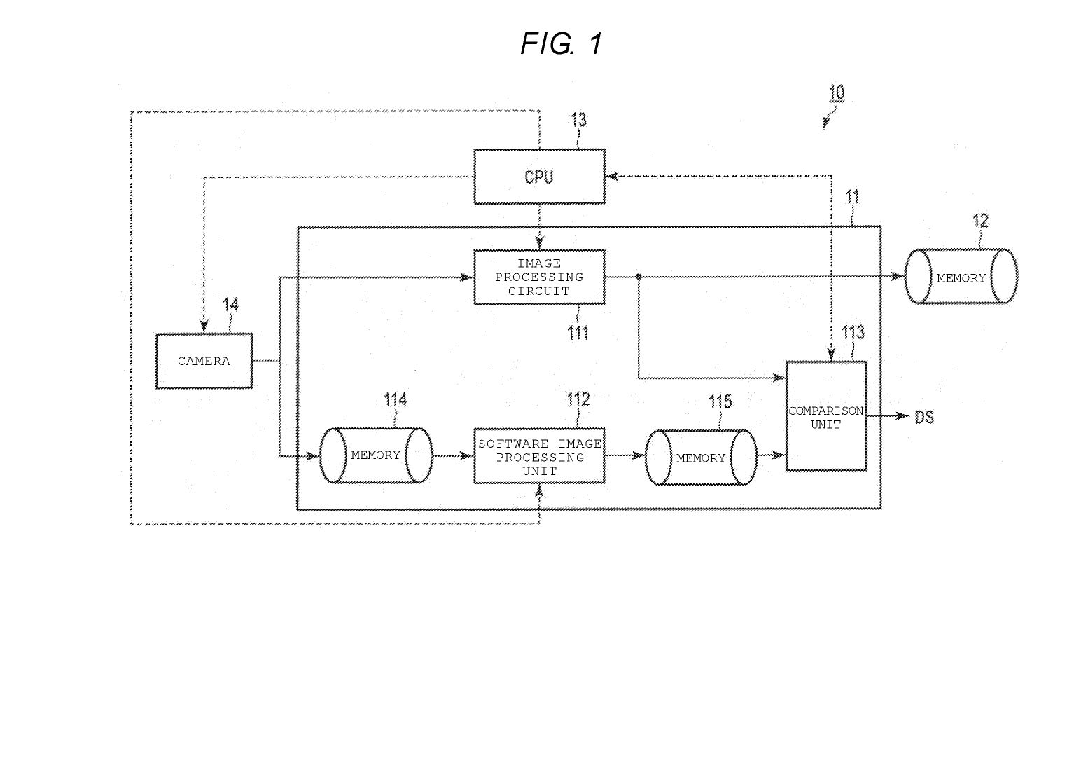

FIG. 1 is a block diagram illustrating a configuration of the semiconductor device including the image processing device according to the first embodiment. As illustrated in the drawing, a semiconductor device 10 includes an image processing device 11, a memory 12, and a central processing unit (CPU) (or a control circuit) 13. In addition, an imaging device, for example, a camera 14 that supplies image data to the image processing device 11 is provided at the exterior of the semiconductor device 10.

The camera 14 generates image data of an image and supplies the image data to the image processing device 11. The image processing device 11 receives the image data from the camera 14 and performs various image processes on the image data and outputs image data which has been subjected to image-processing. Details of the image processing device 11 will be described herein.

The memory 12 stores the image data, which has been subjected to image-processing, which is output from the image processing device 11. The image data stored in the memory 12 is read out by a circuit at a subsequent stage of the memory 12 and used as necessary. The CPU 13 controls the camera 14 and the image processing device 11.

The image processing device 11 includes an image processing circuit 111, a software image processing unit 112, a comparison unit 113, a memory 114, and a memory 115.

The image processing circuit 111 performs hardware-based image processing on the image data received from the camera 14, and outputs the image data which has been subjected to image-processing (hereinafter, a first-processed data) to the memory 12 and the comparison unit 113. The function of image processing in the image processing circuit 111 is realized by hardware such as circuit elements or the like. Hereinafter, the image processing performed by the image processing circuit 111 will be referred to as hardware processing or circuit processing.

The memory 114 stores the image data supplied from the camera 14. The software image processing unit 112 performs the same image processing as that of the image processing circuit 111 on the image data read from the memory 114 using a processor (for example, a dedicated CPU or the CPU 13, and an arithmetic circuit), and outputs the image data which has been subjected to image-processing (hereinafter, referred to as a second-processed data) to the memory 115. The software image processing unit 112 performs the image processing using an arithmetic calculation performed by the processor based on a software program. Hereinafter, the image processing performed by the software image processing unit 112 will be referred to as software processing. Details of the image processing circuit 111 and the software image processing unit 112 will be described below.

The comparison unit 113 compares the first-processed data received from the image processing circuit 111 and the second-processed data received from the memory 115, and outputs a detection signal DS indicating whether or not the first-processed data and second-processed data match. When the detection signal DS indicating a match is output from the comparison unit 113, the CPU 13 determines that the image processing circuit 111 is not in a failure mode, that is, it is in normal operating condition. On the other hand, when the detection signal DS indicating a mismatch is output, the CPU 13 determines that the image processing circuit 111 is in a failure mode.

The comparison unit 113 includes hardware such as circuit elements or the like and performs the comparison between the first-processed data and the second-processed data using the hardware. Alternatively, the comparison unit 113 may include a processor such as a CPU and may perform the comparison between the first-processed data and the second-processed data using the processor based on a processor program. As the processor used in the comparison unit 113, a dedicated processor may be provided or the CPU 13 or another CPU may be used. Furthermore, the program used in the comparison unit 113 may be stored in the memory and may be read and used before performing of the comparison. As the memory in which the program used in the comparison unit 113 is stored, for example, a dedicated memory may be provided or the below-described ROM 302 may be used.

In addition, in some cases, the comparison unit 113 outputs the detection signal DS indicating a mismatch even in a case where a failure does not occur in the image processing circuit 111 due to a difference in accuracy of the image data output by the image processing circuit 111 and the image data output by the software image processing unit 112. In order to resolve this problem, a configuration is provided, in which an allowable error is set for the comparison result from the comparison unit 113 and the comparison unit 113 regards the result as a match if the image differences are within the allowable error range. In addition, a case where a failure occurs in the CPU 13 itself can also be considered. Therefore, the detection of the failure in the CPU 13 is secured in advance using a mechanism such as a dual lock step. The dual lock step is one of security mechanisms for monitoring the operations of the processor such as the CPU or the like. In the dual lock step, clocks of a plurality of the processors are synchronized with each other, and then, the same processing is performed by each processor. Then, processing is performed to check that the processing results of each processor are the same.

### 1-1-1. Image Processing Circuit 111

As described above, in the image processing circuit 111, the function of image processing is realized by hardware such as the circuit elements or the like. The image processing circuit 111 performs the hardware processing on the image data received by the camera 14, and outputs the image data which has been subjected to hardware-processing (first-processed data) to the memory 12 and the comparison unit 113. Processing items described below are examples of the image processing of the image processing circuit 111. The examples are: demosaic, gamma correction, color space conversion, scaling, white balance adjustment, HDR (high dynamic range) compression and decompression, brightness and contrast adjustment, edge emphasis, and the like. Hereinafter, each image process example is described.

Demosaic process: RAW format data which is input from the camera is converted to RGB. The RAW format data is image data captured by the camera which is not yet processed. In addition, the image data includes a plurality of pixel data items. Furthermore, the pixel data includes three values of color, specifically the values of red, green, and blue. These red, green, and blue are referred to as R, G, and B respectively.

Gamma correction process: A gradation of the image is adjusted.

Color space conversion process: the color space of the image is converted. For example, the conversion from RGB to YUV and the conversion from YUV to RGB are performed. YUV indicates a color space where Y represents a brightness signal, U represents a color difference signal (Cb), and V represents a color difference signal (Cr).

Scaling process: the image is enlarged or reduced.

White balance adjustment process: The white balance of the image is adjusted.

HDR compression and decompression processes: A HDR compression or a HDR decompression is performed on the image data.

Brightness and contrast adjustment process: The brightness and contrast of the image are adjusted.

Edge emphasis process: An edge of the image is emphasized.

The image processing circuit 111 includes circuits that perform the image processing processes described above. Here, three circuits that perform the individual image processing are illustrated, and those are referred to as image processing circuits (A), (B), and (C) respectively. The image processing circuits (A), (B), and (C) perform the hardware processing on the image data.

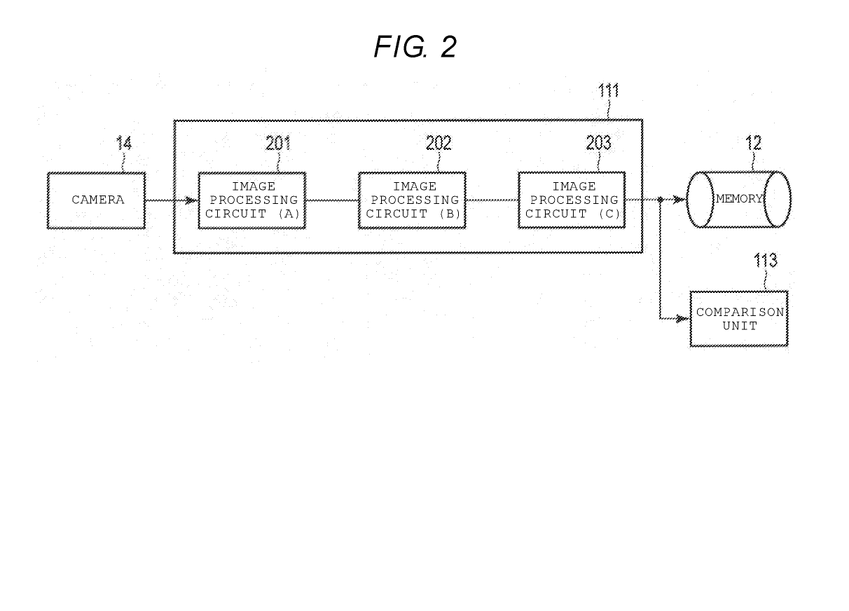

FIG. 2 is a block diagram illustrating a configuration example of an image processing circuit 111 in the first embodiment. The image processing circuit 111 has a configuration in which an image processing circuit (A) 201, an image processing circuit (B) 202, and an image processing circuit (C) 203 are serially connected (connected in series).

For example, the demosaic processing is performed by the image processing circuit (A). Next, the gamma correction processing is performed by the image processing circuit (B). Furthermore, the color space conversion processing is performed by the image processing circuit (C). As described above, the image processing circuits (A), (B), and (C) perform this image processing.

In the image processing circuit (A), the demosaic processing function is realized by hardware such as circuit elements. In the image processing circuit (B), the gamma correction processing function is realized by hardware such as circuit elements. In the image processing circuit (C), the color space conversion processing function is realized by hardware such as circuit elements.

### 1-1-2. Software Image Processing Unit 112

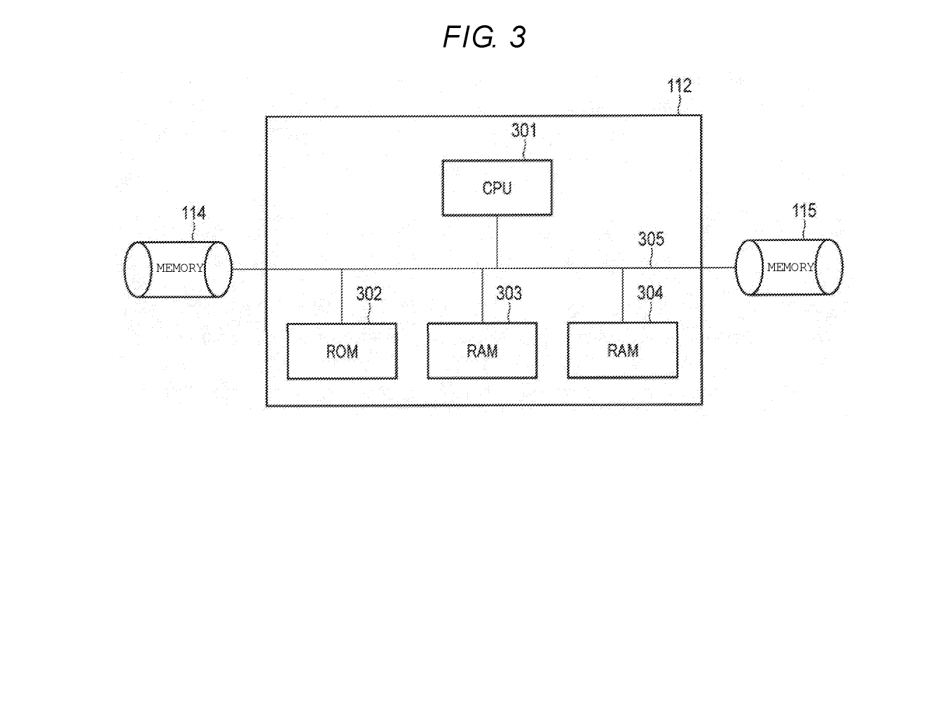

FIG. 3 is a block diagram illustrating a configuration of the software image processing unit 112 according to the first embodiment. The software image processing unit 112 includes a CPU 301, a ROM 302, a RAM 303, and a RAM 304, connected together on a bus 305.

The ROM 302 stores a boot program (or a control program) and an image processing program. The CPU 301 performs the image processing, that is, the arithmetic processing on the image data based on the image processing program. The RAM 303 and the RAM 304 are used as an operation region of the CPU 301. The RAM 303 includes, for example, a DRAM for a high speed access. The RAM 304 includes, for example, an SRAM for handling large volume data. Instead of the RAM 303 and the RAM 304, other types of RAMs may be used according to the use environment.

When the CPU 301 is started, the CPU 301 performs initialization of the necessary hardware, that is, of the RAM 303 and the RAM 304 using the boot program stored in the ROM 302. Furthermore, the CPU 301 develops the image processing program in the ROM 302 into the RAM 303 using the boot program. Then, the CPU 301 reads the image data from the memory 114 and performs the image processing on the read image data based on the image processing program in the RAM 303. That is, the CPU 301 operates according to the image processing program and performs the arithmetic calculations as the image processing on the received image data. Procedures for various image processing items are described in the image processing program. Intermediate data generated in the process of the image processing by the CPU 301 is once written into the RAM 303 or the RAM 304 and then read again by the CPU 301.

The CPU 301 may be a dedicated unit used in the software image processing unit 112 or may be a unit arranged in the CPU 13 or another circuit region. In other words, the CPU 13 illustrated in FIG. 1 may serve as the CPU 301 or the CPU 301 may be provided separately from the CPU 13. In a case where the CPU 13 and the CPU 301 are separately provided, in some cases, a communication link between the CPU 13 and the CPU 301 is needed to control the timing of the receipt of the image data.

In addition, instead of the CPU 301, a processor specialized for digital signal processing such as a digital signal processor (DSP) can be used. Generally, the image processing can be performed at a high speed when using a DSP specialized for digital signal processing rather than using the CPU. In addition, the memory 114 or the memory 115 illustrated in FIG. 1 may be included in the RAM 303 or the RAM 304.

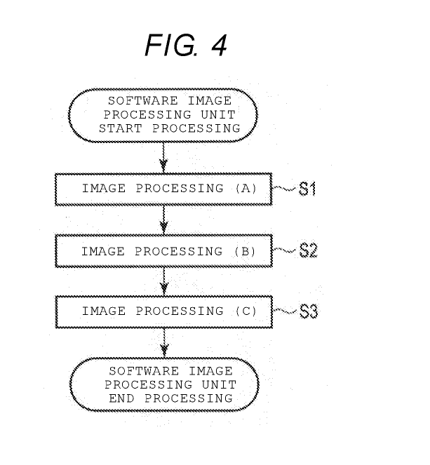

FIG. 4 is a flowchart illustrating a processing example by the software image processing unit 112 in the first embodiment. The software image processing unit 112 can perform the image processing items such as demosaic, gamma correction, color space conversion, scaling, white balance adjustment, HDR compression and decompression, brightness and contrast adjustment, edge emphasis, and the like similarly to the image processing circuit 111. Here, three processing units that perform the individual image processing items are illustrated, and those are referred to as image processing units (A), (B), and (C) respectively. Each image processing unit (A), (B), and (C) performs software processing on the image data. Each image processing unit (A), (B), and (C) corresponds to the image processing circuit (A), (B), and (C) in the image processing circuit 111, respectively. That is, the image processing unit (A) has a function the same as that of the image processing circuit (A), the image processing unit (B) has a function the same as that of the image processing circuit (B), and the image processing unit (C) has a function the same as that of the image processing circuit (C).

As illustrated in FIG. 4, when the image processing in the software image processing unit 112 is started, the CPU 301 sequentially performs the image processing on the image data in such a manner of performing the image processing in image processing unit (A) (STEP S1), subsequently performing the image processing in image processing unit (B) (STEP S2), and subsequently performing the image processing in image processing unit (C) (STEP S3). Thereafter, the image processing by the software image processing unit 112 is ended.

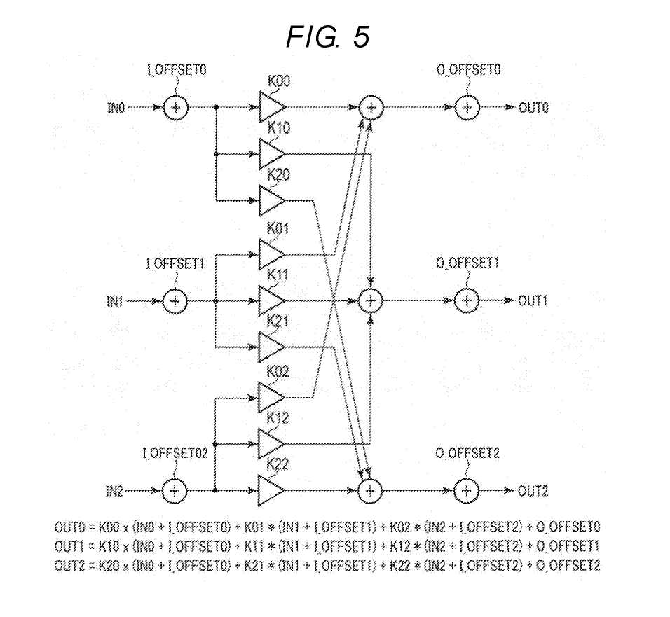

Next, as an example of the image processing performed by each image processing circuit (A), (B), and (C) in the image processing circuit 111 and each image processing unit (A), (B), and (C) of the software image processing unit 112, the color space conversion process will be described. As an example of the image processing, matrix conversion processing for performing the color space conversion is illustrated in FIG. 5.

Conversion formula are given by a combination of the color space before the conversion and the color space after the conversion, and each parameter for the matrix conversion processing is given based on the conversion formula.

For example, the conversion formula from an 8-bit full scale RGB to a YCbCr stipulated in the ITU-R BT.601 is given as follows.

Y=0.257R+0.504G+0.098B+16, Cb=−0.148R−0.291G+0.439B+128, and Cr=0.439R−0.368G−0.071B+128. At this time, each parameter of the matrix conversion processing is as follows.

I_FFSET0=0, I_OFFSET1=0, I_OFFSET2=0. K00=0.257, K01=0.504, K02=0.098, K10=−0.148, K11=−0.291, K12=0.439, K20=0.439, K21=−0.368, K22=−0.071. O_OFFSET0=16, O_OFFSET1=128, O_OFFSET2=128. Each output OUT0, OUT1, and OUT2 is expressed as follows.

OUT0=K00×(IN0+I_OFFSET0)+K01*(IN1+I_OFFSET1)+K02*(IN2+I_OFFSET2)+O_OFFSET0OUT1=K10×(IN0+I_OFFSET0)+K11*(IN1+I_OFFSET1)+K12*(IN2+I_OFFSET2)+O_OFFSET1 OUT2=K20×(IN0+I_OFFSET0)+K21*(IN1+I_OFFSET1)+K22*(IN2+I_OFFSET2)+O_OFFSET2

In the image processing circuit 111, the matrix conversion processing illustrated in FIG. 5 is performed by, for example, the image processing circuit (C) including the circuit elements. On the other hand, in the software image processing unit 112, the matrix conversion processing illustrated in FIG. 5 is performed by arithmetic calculation by the CPU 301.

### 1-2. Operation of the Semiconductor Device

The operation of the semiconductor device 10 including the image processing device 11 according to the first embodiment will be described.

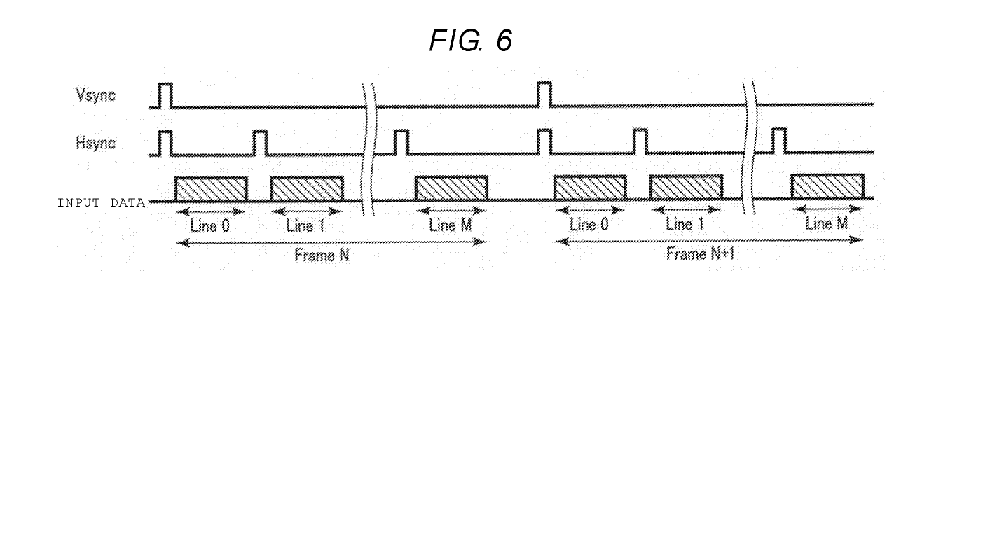

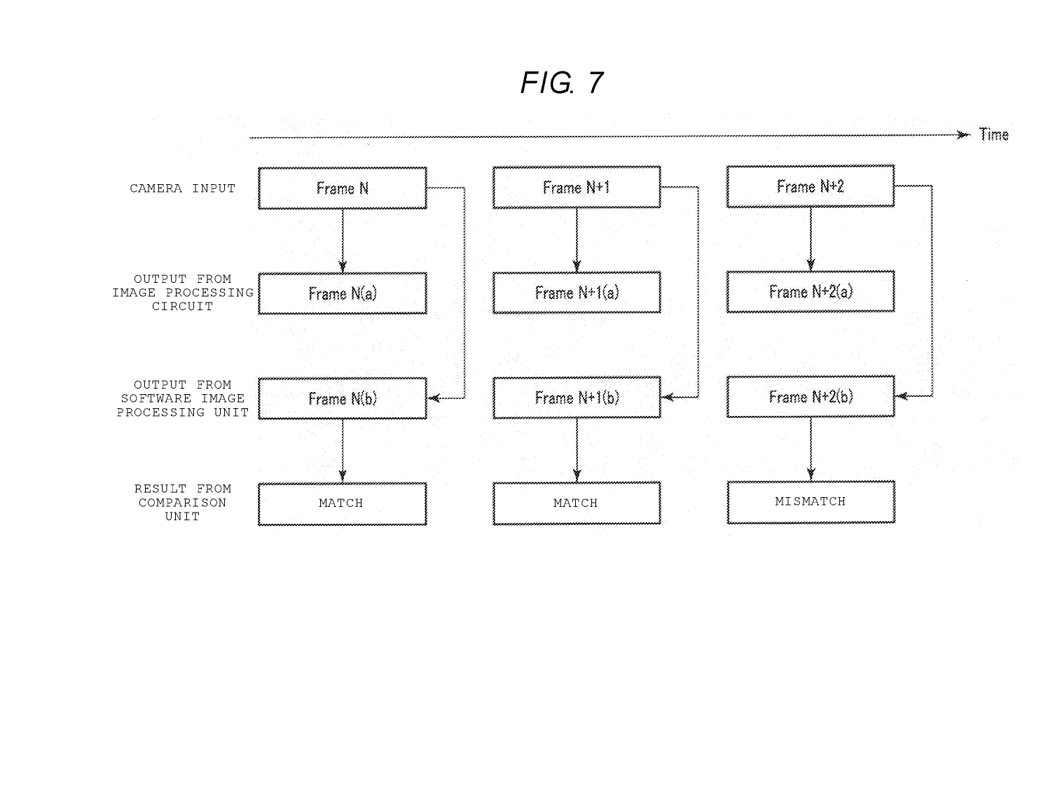

FIG. 6 illustrates an example of the image data output from the camera 14. FIG. 7 is a timing chart illustrating the operation of the semiconductor device according to the first embodiment.

First, the image data supplied from the camera 14, here, a case of supplying the image data in a parallel interface, will be described with reference to FIG. 6.

A signal Vsync, a signal Hsync, and input data are input from a plurality of input lines as image data. For example, the number of input lines is 16 lines or 24 lines (the number of input bits is 16 bits or 24 bits). The signal Vsync indicates a synchronized signal in the vertical direction of the image. The signal Hsync indicates a synchronized signal in the horizontal direction of the image. A frame N includes signals of line 0, line 1, line 2, . . . line M. N and M are natural numbers equal to or greater than zero.

The operation of the image processing device 11 according to the first embodiment will be described below with reference to FIG. 7. Here, an example of comparing the output of the image processing circuit 111 and the output of the software image processing unit 112 for each frame is illustrated.

First, the image processing for the frame N will be described. The frame N is supplied to the image processing circuit 111 and the memory 114 from the camera 14. The image processing circuit 111 receives the frame N and performs the hardware processing on the frame N, and then, outputs a frame N(a) which has been subjected to hardware-processing. The frame N(a) corresponds to the first-processed data.

The software image processing unit 112 performs the software processing on the frame N read from the memory 114, and then, outputs a frame N(b) which has been subjected to software-processing to the memory 115. The frame N(b) corresponds to the second-processed data.

The comparison unit 113 compares the frame N(a) and the frame N(b) read from the memory 115 and outputs the detection signal DS indicating whether or not those frames match with each other. When the detection signal DS output from the comparison unit 113 indicates a match, the CPU 13 determines that the image processing circuit 111 is not in failure mode, that is, it is in normal operating condition. On the other hand, when the detection signal DS output from the comparison unit 113 indicates a mismatch, the CPU 13 determines that the image processing circuit 111 is in failure mode.

Next, the image processing for the frame N+1 supplied from the camera 14 will be described. The image processing for the frame N+1 is similar to that for the frame N. The frame N+1 is supplied to the image processing circuit 111 and the memory 114 from the camera 14. The image processing circuit 111 performs the hardware processing on the frame N+1, and then, outputs a frame N+1 (a) which has been subjected to hardware-processing.

The software image processing unit 112 also performs the software processing on the frame N+1, and then, outputs a frame N+1 (b) which has been subjected to software-processing.

The comparison unit 113 compares the frame N+1(a) and the frame N+1(b), and outputs the detection signal DS indicating whether or not those frames match with other. When the detection signal DS output from the comparison unit 113 indicates a match, the CPU 13 determines that the image processing circuit 111 is in normal operating condition. On the other hand, when the detection signal DS output from the comparison unit 113 indicates a mismatch, the CPU 13 determines that the image processing circuit 111 is in failure mode.

Next, the image processing for the frame N+2 supplied from the camera 14 will be described. Since the image processing items for the frame N+2 is also similar to that of the frame N and the frame N+1, and thus, the description thereof will be omitted.

In FIG. 7, in the image processing for the frame N, a case where the comparison result between the frame N(a) and the frame N(b) indicates the match, and thus, a failure mode has not occurred, is described. In the image processing for the frame N+1, a case where the comparison result between the frame N+1 (a) and the frame N+1 (b) indicates the match, and thus, the failure mode has not occurred, is described. In the image processing for the frame N+2, a case where the comparison result between the frame N+2 (a) and the frame N+2 (b) indicates the mismatch, and thus, the failure mode has occurred, is shown.

### 1-3. Effects of the First Embodiment

According to the semiconductor device including the image processing device according to the first embodiment, the failure in the image processing circuit performing the image data processing can be detected. Thus, it is possible to reduce the size of the circuit, the power consumption of the circuit, and the failure rate of the circuit, because an additional test circuit, likewise subject to potential failure, is not required.

Hereafter, the effects of the embodiment will be described in detail.

In the present embodiment, in the image processing device including the image processing circuit 111 that performs the image processing on the image data, the software image processing unit 112 has an image processing function the same as that in the image processing circuit 111. The image data (first-processed data) processed by the image processing circuit 111 and the image data (second-processed data) processed by the software image processing unit 112 are compared, and whether or not the image processing circuit 111 is in failure mode is determined based on whether or not the first-processed data and the second-processed data match with each other. The image processing circuit 111 includes hardware such as the circuit elements or the like, and the software image processing unit 112 performs the image processing using the processor based on the image processing program.

Thereby, the second-processed data that is compared with the first-processed data output from the image processing circuit 111 can be generated by the software image processing unit 112. Therefore, the size of the circuit, the power consumption, and the failure rate can be reduced, as compared to the case of providing the image processing circuit similar to the image processing circuit 111.

As described above, according to the present embodiment, a failure in the image processing circuit performing the image data processing can be detected. Thus, it is possible to provide the semiconductor device including the image processing device having a reduced size of the circuit, power consumption, and failure rate, because an additional test circuit, likewise subject to potential failure, is not required.

### 2. Second Embodiment

A semiconductor device including an image processing device of the second embodiment will be described. In the second embodiment, it is determined whether or not an image processing circuit 111 is in failure mode by comparing only portions of the data items from among the image data items in one frame. A configuration of the image processing device 11 is similar to that in the first embodiment. Hereinafter, in the second embodiment, points different from those in the first embodiment will mainly be described.

### 2-1. Operation of the Image Processing Device

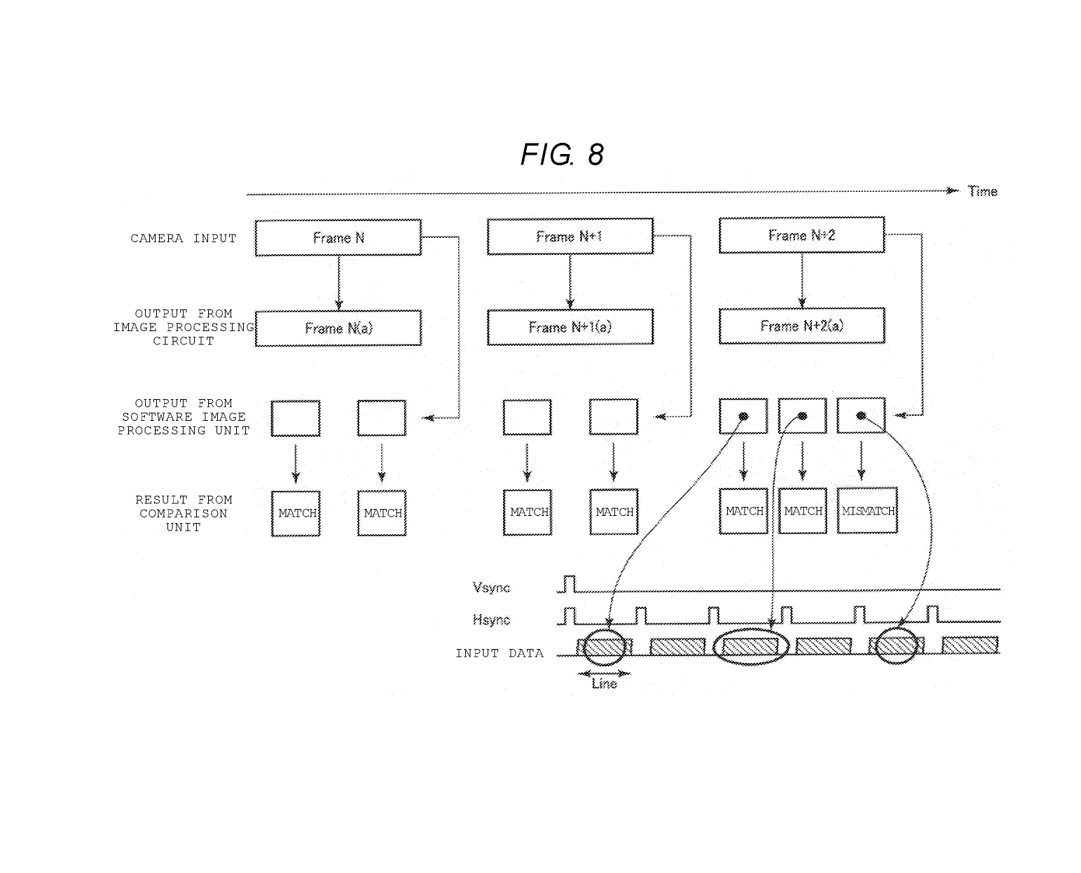

FIG. 8 is a timing chart illustrating an operation of the image processing device according to the second embodiment.

First, the image processing for the frame N will be described. The frame N is supplied to both the image processing circuit 111 and the memory 114 from the camera 14. The image processing circuit 111 receives the frame N and performs the hardware processing on the frame N, and outputs the frame N(a) which has been subjected to hardware-processing.

The software image processing unit 112 receives a relevant portion of the data among the data items in the frame N read from the memory 114. The software image processing unit 112 performs the software processing on the received portion of data and outputs the portion of data which has been subjected to software-processing to the memory 115. The portion of data is, for example, a line of data, a plurality of lines of data, or a specific portion of data in a line among the image data items in the frame N.

The comparison unit 113 compares a portion of the data in the frame N(a) output from the image processing circuit 111 and the portion of the data which has been subjected to software-processing output from the memory 115. The comparison unit 113 outputs a detection signal DS indicating whether or not the portion of the data in the frame N(a) and the portion of the data which has been subjected to software-processing match with each other. The portion of the data from the processed frame of the image processing circuit 111 and the portion of the data from the software image processing unit 112 that are compared with each other in the comparison unit 113 are data items corresponding to each other, for example, they are both data items in the same line in the frame N or they are both data items in the same part of the same line.

When the detection signal DS output from the comparison unit 113 indicates a match, the CPU 13 determines that the image processing circuit 111 is not in failure mode, that is, it is in normal operating condition. On the other hand, when the detection signal DS output from the comparison unit 113 indicates a mismatch, the CPU 13 determines that the image processing circuit 111 is in failure mode.

The image processing for the frame N+1 or the frame N+2 is also the same as that for the frame N, and thus, the description thereof will be omitted.

In FIG. 8, in the image processing for the frame N, a case where the comparison result between the portion of the data in the frame N(a) and the portion of the data from the software image processing unit 112 indicates a match, and thus, the failure mode did not occur, is described. In the image processing for the frame N+1, a case where the comparison result between the part of the data in the frame N+1(a) and the part of the data from the software image processing unit 112 indicates a match, and thus, the failure does not occur, is described. In the image processing for the frame N+2, a case where the comparison result between the part of the data in the frame N+2 (a) and the part of the data from the software image processing unit 112 indicates a mismatch, and thus, the failure occurs, is described.

### 2-2. Effects of the Second Embodiment

In the second embodiment, the software image processing unit 112 performs the image processing on a portion of the data among the image data items in the frame N output from the camera 14 and held in the memory 114. The comparison unit 113 compares the portion of the data which has been subjected to image-processing by the software image processing unit 112 and the portion of data the in the frame N which has been subjected to image-processing in the image processing circuit 111. The two portions of the data items compared in the comparison unit 113 are the data items of portions of the image corresponding to each other among the image data items in the frame N. The CPU 13 determines whether or not the image processing circuit 111 is in failure mode according to the comparison result in the comparison unit 113.

Thereby, by making the portion of data among the image data items in the frame N as the comparison target, it is possible to reduce the time required for the image processing by the software image processing unit 112 and the time required for the comparison in the comparison unit 113. Furthermore, since the time required for image processing performed by the software image processing unit 112 can be reduced, it is possible that the CPU 13 performs the image processing by the software image processing unit 112 using operational free time in the CPU 13.

As described above, according to the second embodiment, by making only a portion of data among the image data items in the frame N as the comparison target, it is possible to reduce the time required for the image processing in the software image processing unit 112. Furthermore, it is possible to reduce the load to the CPU 301 (the processor) used for the software processing in the software image processing unit 112. Other configurations and effects are similar to those in the first embodiment.

### 3. Third Embodiment

A semiconductor device including an image processing device according to a third embodiment will be described. In the third embodiment, a few circuits are selected from a plurality of circuits performing the image processing included in the image processing circuit, and it is determined whether or not the selected circuits are in failure mode. Hereinafter, in the third embodiment, points different from those in the first embodiment will mainly be described.

### 3-1. Configuration of a Semiconductor Device

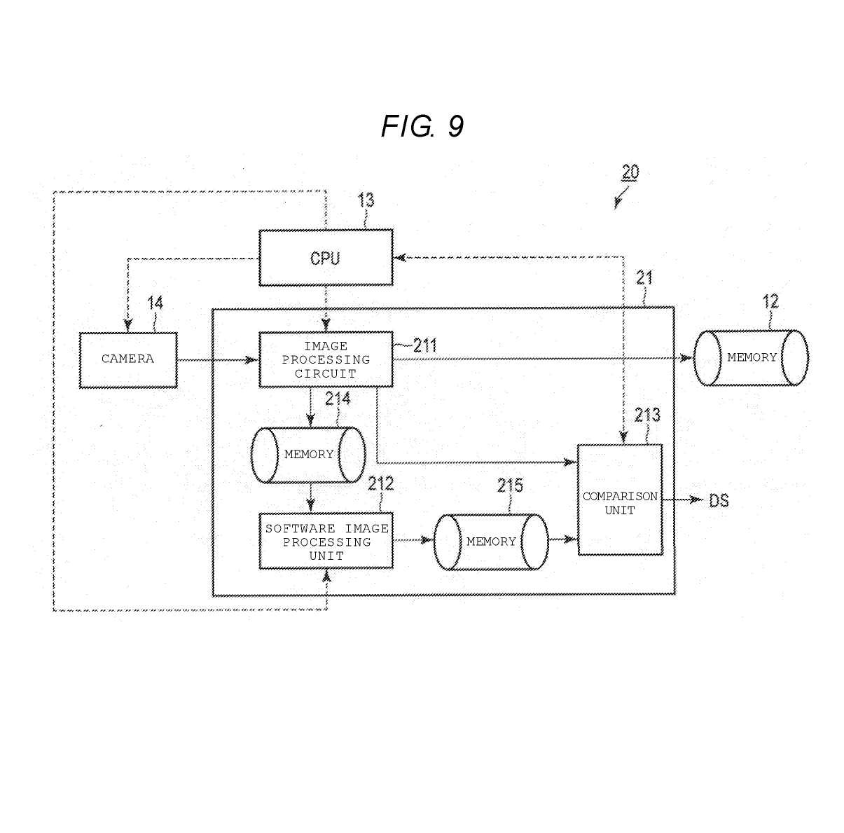

FIG. 9 is a block diagram illustrating a configuration of the semiconductor device including the image processing device according to the third embodiment. As illustrated in FIG. 9, a semiconductor device 20 includes an image processing device 21, a memory 12, and a CPU 13. In addition, the camera 14 that supplies image data to the image processing device 21 is provided at the exterior of the semiconductor device 20.

The camera 14 generates image data based on the image and supplies the image data to the image processing device 21. The image processing device 21 receives the image data from the camera 14 and performs various image processing items on the image data and outputs the image data which has been subjected to image-processing. Details of the image processing device 21 will be described below.

The memory 12 stores the image data which has been subjected to image-processing output from the image processing device 21. The image data stored in the memory 12 is read out by a circuit provided at a subsequent stage of the memory 12 and used as necessary. The CPU 13 controls the camera 14 and the image processing device 21.

The image processing device 21 includes an image processing circuit 211, a software image processing unit 212, a comparison unit 213, a memory 214, and a memory 215.

The image processing circuit 211 performs hardware-based image processing (hereinafter, referred to as hardware processing or circuit processing) on the image data received from the camera 14, and outputs the image data which has been subjected to hardware-processing (hereinafter, referred to as third-processed data) to the memory 214, the memory 12, and the comparison unit 213. Depending on the cases, the image data before the image processing is output to the memory 214. The function of image processing in the image processing circuit 211 is realized by hardware such as circuit elements or the like.

The memory 214 stores the image data output from the image processing circuit 211. The configuration of the software image processing unit 212 is similar to the configuration illustrated in FIG. 3. The software image processing unit 212 performs image processing (hereinafter, software processing) the same as that of the image processing circuit 211 on the image data read from the memory 214 using a processor (for example, the CPU 301 or an arithmetic circuit), and outputs the image data which has been subjected to software-processing (hereinafter, referred to as a fourth-processed data) to the memory 215. The software image processing unit 212 performs the image processing by an arithmetic calculation performed by the processor based on a program. Details of the image processing circuit 211 will be described below. The software image processing unit 212 has a configuration similar to that of the software image processing unit 112.

The comparison unit 213 compares the third-processed data received from the image processing circuit 211 and the fourth-processed data received from the memory 215, and outputs a detection signal DS indicating whether or not the third-processed data and the fourth-processed data match. When the detection signal DS indicating a match is output from the comparison unit 213, the CPU 13 determines that the image processing circuit 211 is not in a failure mode, that is, it is in normal operating condition. On the other hand, when the detection signal DS indicating a mismatch is output, the CPU 13 determines that the image processing circuit 211 is in failure mode.

Similarly to the comparison unit 113, the comparison unit 213 includes hardware such as circuit elements and performs the comparison between the third-processed data and the fourth-processed data using the hardware. Alternatively, the comparison unit 213 may include a processor such as a CPU and may perform the comparison between the third-processed data and the fourth-processed data using the processor based on the program.

### 3-1-1. Image Processing Circuit 211

As described above, the image processing circuit 211 performs the hardware processing on the image data received from the camera 14 and outputs the image data selected from the image data which has been subjected to hardware-processing by a selector to the memory 214 and the comparison unit 213. Depending on the selection by the selector, in some cases, the image data before a specific image processing item is performed is output to the memory 214. As described above, the below-described processing items are examples of the image processing. The examples of image processing items include: Demosaic processing, gamma correction processing, color space conversion processing, scaling processing, white balance adjustment processing, HDR compression decompression processing, brightness and contrast adjustment processing, edge emphasis processing, and the like.

Similarly to the first embodiment, the image processing circuit 211 includes the circuits that perform the image processing items described above. Here, three circuits that perform the individual image processing are also illustrated, and are referred to as image processing circuits (A), (B), and (C) respectively.

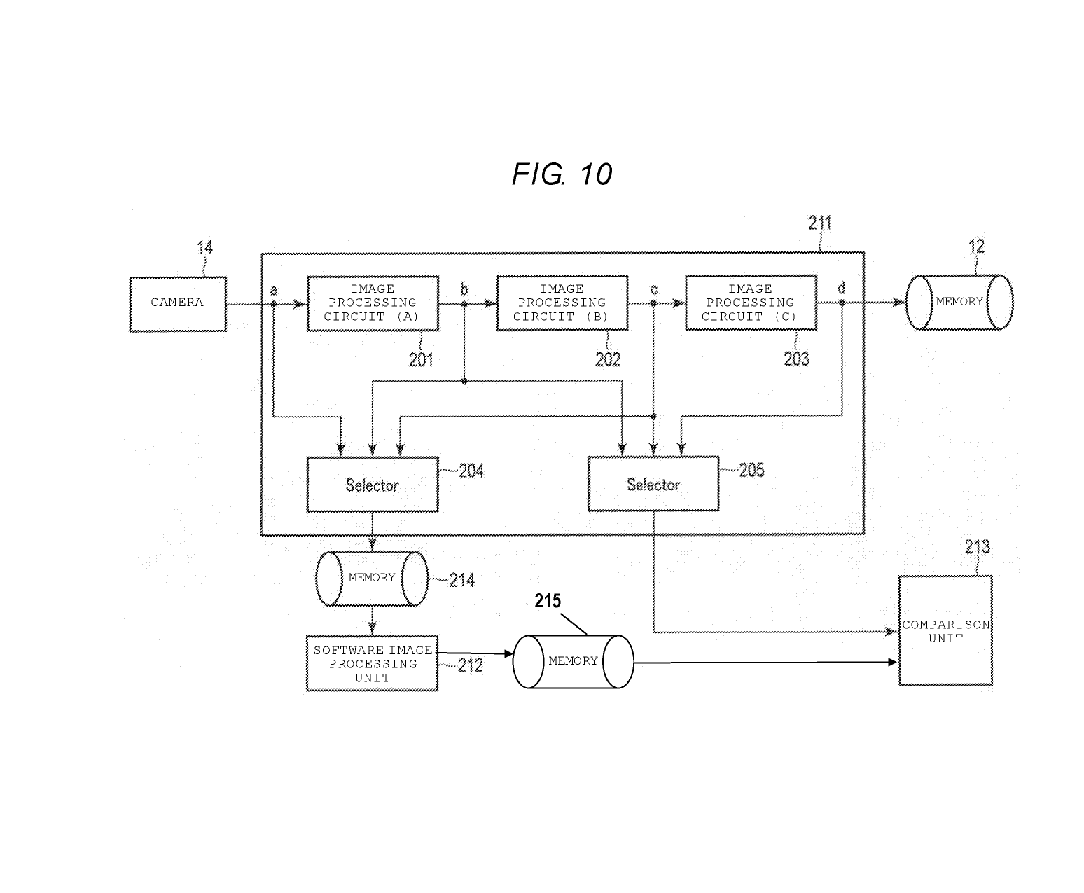

FIG. 10 is a block diagram illustrating a configuration example of the image processing circuit 211 according to the third embodiment. The image processing circuit 211 has a configuration in which an image processing circuit (A) 201, an image processing circuit (B) 202, and an image processing circuit (C) 203 are serially connected. The image processing circuit 211 includes selectors 204 and 205.

The selector 204 is connected to a node a between the camera 14 and the image processing circuit (A) 201, to a node b between the image processing circuit (A) 201 and the image processing circuit (B) 202, and to a node c between the image processing circuit (B) 202 and the image processing circuit (C) 203. The selector 205 is connected to the node b between the image processing circuit (A) 201 and the image processing circuit (B) 202, to the node c between the image processing circuit (B) 202 and the image processing circuit (C) 203, and to a node d between the image processing circuit (C) 203 and the memory 12.

The selector 204 selects any of the nodes among the nodes a, b, and c according to the control by the CPU 13, and outputs the image data of the selected node to the memory 214. The selector 205 selects any of the nodes among the nodes b, c, and d according to the control by the CPU 13, and outputs the image data of the selected node to the comparison unit 213.

### 3-1-2. Software Image Processing Unit 212

The configuration of the software image processing unit 212 according to the third embodiment is similar to the configuration illustrated in FIG. 3.

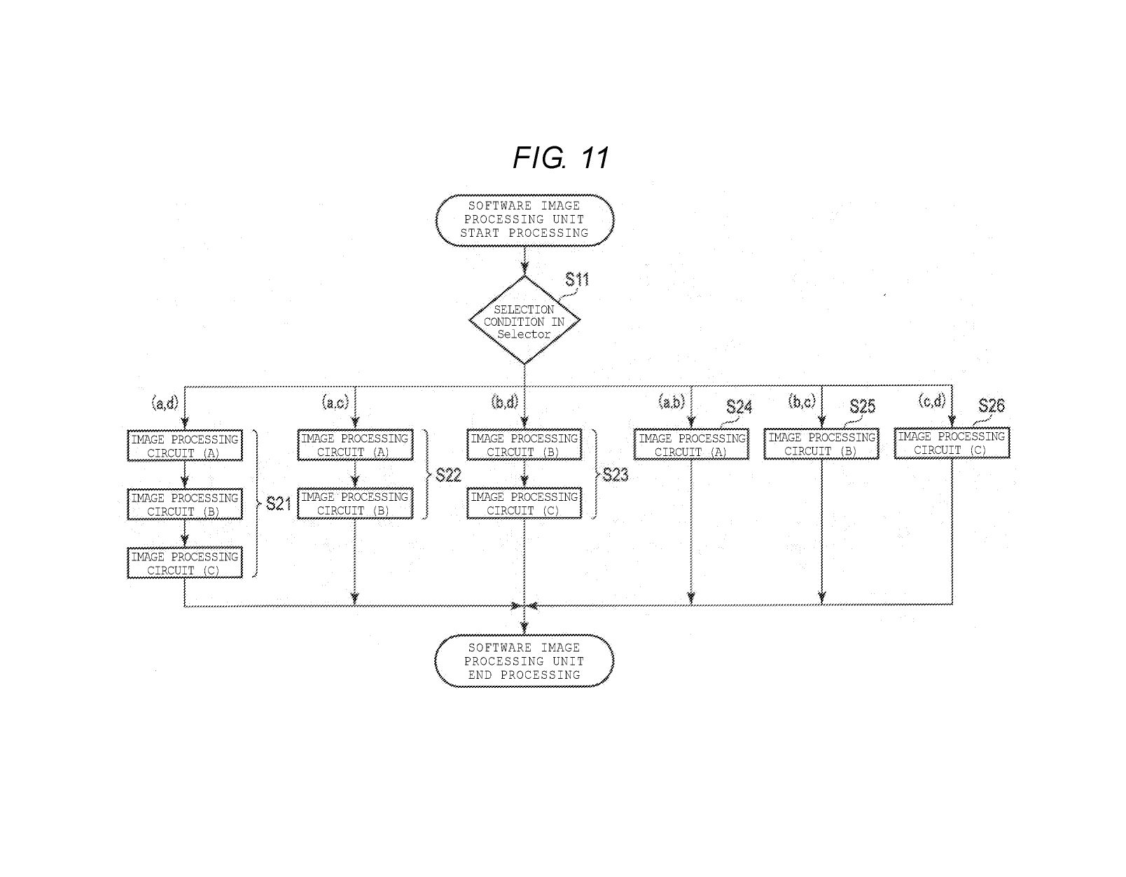

FIG. 11 is a flowchart illustrating a processing example of the software image processing unit 212 according to the third embodiment. Similarly to the image processing circuit 211, the software image processing unit 212 can perform the image processing, for example, demosaic processing, gamma correction processing, color space conversion processing, scaling processing, white balance adjustment processing, HDR compression and decompression processing, brightness and contrast adjustment processing, edge emphasis processing, and the like. Similarly, three processing units that perform the individual image processing items are also illustrated, and are referred to as image processing units (A), (B), and (C) respectively.

As illustrated in FIG. 11, when the image processing in the software image processing unit 212 is started, the CPU 301 performs anyone of the processing or a plurality of processing items among the image processing items (A), (B), and (C) according the control by the CPU 13 in accordance with selection conditions (STEP S11) in the selectors 204 and 205.

For example, in a case where the node a is selected in the selector 204 and the node d is selected in the selector 205, the software image processing unit 212 performs the image processing items (A), (B), and (C) (STEP S21). In a case where the node a and c are selected in the selectors 204 and 205 respectively, the software image processing unit 212 performs the image processing items (A) and (B) (STEP S22). Similarly, in a case where the node b and d are selected in the selectors 204 and 205 respectively, the software image processing unit 212 performs the image processing items (B) and (C) (STEP S23). In a case where the node a and b are selected in the selectors 204 and 205 respectively, the software image processing unit 212 performs the image processing item (A) (STEP S24). In a case where the node b and c are selected in the selectors 204 and 205 respectively, the software image processing unit 212 performs the image processing items (B) (STEP S25). In a case where the node c and d are selected in the selectors 204 and 205 respectively, the software image processing unit 212 performs the image processing items (C) (STEP S26). Subsequently, the image processing in the software image processing unit 212 ends.

Here, the case where the CPU 301 performs the image processing items (A), (B), and (C) is described. Alternatively, the CPU 13 may perform these processing items.

Hereinafter, an example of a case will be described, in which the selectors 204 and 205 select the circuits for performing the failure detection from the image processing circuits (A), (B), and (C) included in the image processing circuit 211 and the selected circuits are used to perform the failure detection.

For example, the operations of the image processing circuit 211 and the software image processing unit 212 in a case of detecting the failure in the image processing circuit (A) 201 in the image processing circuit 211 are as described below.

In a case of detecting whether or not the image processing circuit (A) 201 is in failure mode, the selector 204 selects the node a. Thereby, the selector 204 outputs the image data which is output from the camera 14 and which is to be subjected to image-processing by the image processing circuit (A) 201, to the memory 214. The selector 205 selects the node b. Thereby, the selector 205 outputs the image data (third-processed data) which is subjected to image-processing by the image processing circuit (A) 201 and which is to be subjected to image-processing by the image processing circuit (B) 202, to the comparison unit 213.

The software image processing unit 212 reads the image data held in the memory 214. The software image processing unit 212 performs the image processing on the image data which is read from the memory 214 and which is to be subjected to image-processing by the image processing circuit (A) 201, and outputs the image data which has been subjected to software-processing (fourth-processed data) to the memory 215.

The comparison unit 213 compares the third-processed data output from the selector 205 in the image processing circuit 211 and the fourth-processed data which is subjected to software-processing by the software image processing unit 212 and held in the memory 215. The comparison unit 213 outputs the detection signal DS indicating whether or not the third-processed data and the fourth-processed data match each other.

Next, the operations of the image processing circuit 211 and the software image processing unit 212 in a case of detecting the failure in the image processing circuit (B) 202 and the image processing circuit (C) 203 in the image processing circuit 211 are as described below.

In a case of detecting whether or not at least one of the image processing circuit (B) 202 and the image processing circuit (C) 203 are in failure mode, the selector 204 selects the node b. Thereby, the selector 204 outputs the image data which is subjected to image-processing by the image processing circuit (A) 201 and which is to be subjected to image-processing by the image processing circuit (B) 202, to the memory 214. The selector 205 selects the node d. Thereby, the selector 205 outputs the image data (third-processed data) which has been subjected to image-processing by the image processing circuit (C) 203 to the comparison unit 213.

The software image processing unit 212 reads the image data held in the memory 214. The software image processing unit 212 performs the image processing (B) and the image processing (C) on the image data which is read from the memory 214 and is subjected to image-processing by the image processing circuit (A) 201, and outputs the image data which has been subjected to software-processing (fourth-processed data) to the memory 215.

The comparison unit 213 compares the third-processed data output from the selector 205 in the image processing circuit 211 and the fourth-processed data which is subjected to software-processing by the software image processing unit 212 and held in the memory 215. The comparison unit 213 outputs the detection signal DS indicating whether or not the third-processed data and the fourth-processed data match with each other.

Next, the operations of the image processing circuit 211 and the software image processing unit 212 in a case of detecting the failure in the image processing circuit (A) 201, the image processing circuit (B) 202 and the image processing circuit (C) 203 in the image processing circuit 211 are as described below.

In a case of detecting whether or not the image processing circuit (A) 201, the image processing circuit (B) 202 and the image processing circuit (C) 203 are in failure mode, the selector 204 selects the node a. Thereby, the selector 204 outputs the image data which is output from the camera 14 and which is to be subjected to image-processing by the image processing circuit (A) 201, to the memory 214. The selector 205 selects the node d. Thereby, the selector 205 outputs the image data (third-processed data) which has been subjected to image-processing by the image processing circuit (A) 201, the image processing circuit (B) 202, and the image processing circuit (C) 203, to the comparison unit 213.

The software image processing unit 212 reads the image data held in the memory 214. The software image processing unit 212 performs the image processing (A), the image processing (B) and the image processing (C) on the image data which is read from the memory 214 and which is to be subjected to image-processing by the image processing circuit (A) 201, and outputs the image data which has been subjected to software-processing (fourth-processed data) to the memory 215.

The comparison unit 213 compares the third-processed data output from the selector 205 in the image processing circuit 211 and the fourth-processed data which is subjected to software-processing by the software image processing unit 212 and held in the memory 215. The comparison unit 213 outputs a detection signal DS indicating whether or not the third-processed data and the fourth-processed data match with each other.

The image processing item (A), the image processing item (B), and the image processing item (C) performed here are the same processing items corresponding to the image processing circuit (A) 201, the image processing circuit (B) 202, and the image processing circuit (C) 203 respectively. Furthermore, the image processing item (A), the image processing item (B), and the image processing item (C) are software processing items performed by the CPU 301.

### 3-2. Operation of the Semiconductor Device

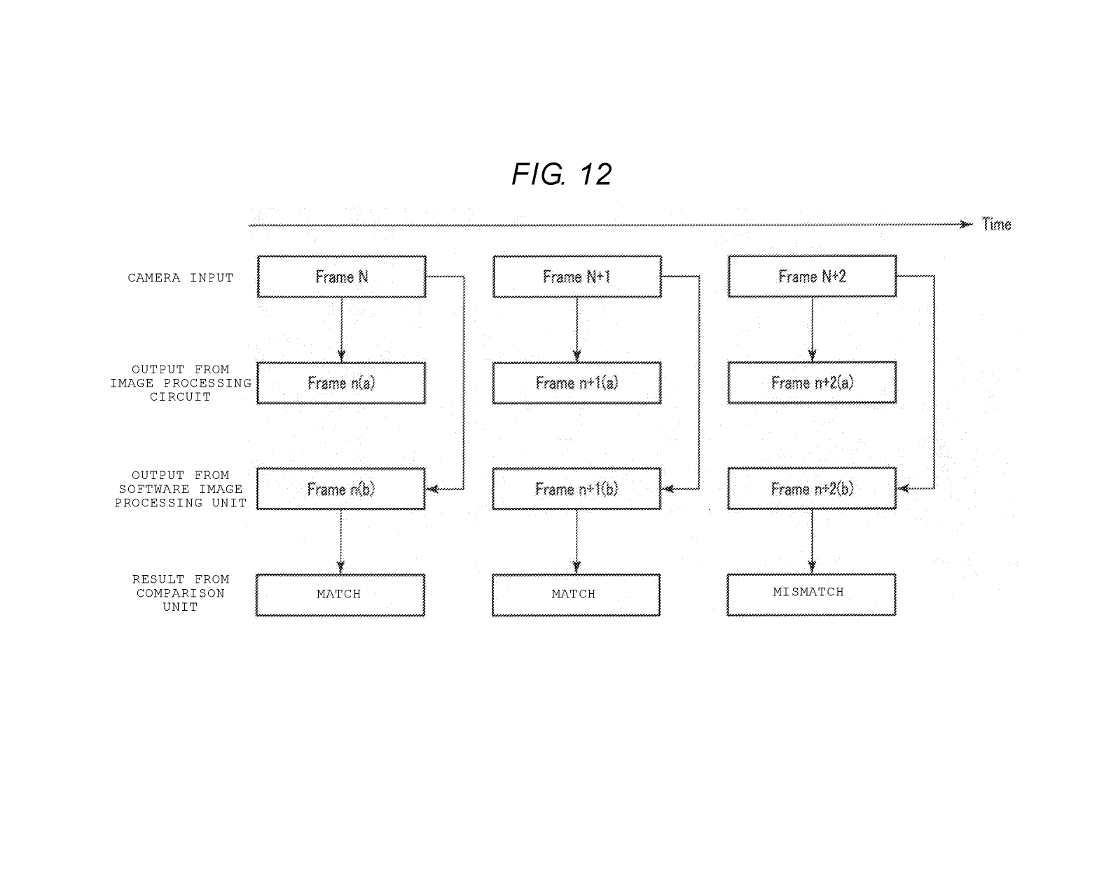

The operation of the semiconductor device 20 including the image processing device 21 according to the third embodiment will be described. FIG. 12 is a timing chart illustrating the operation of the semiconductor device according to the third embodiment. A case of detecting the failure in the image processing circuit (A) 201 in the image processing circuit 211 will be described as an example.

First, the frame N is supplied to the image processing circuit 211 from the camera 14. The image processing circuit 211 receives the frame N and performs the hardware processing on the frame N using the image processing circuits (A) 201, (B) 202, and (C) 203, and outputs the frame N(a) which has been subjected to hardware-processing to the memory 12.

In a case of detecting whether or not the image processing circuit (A) 201 is in failure mode, the selector 204 selects the node a. Thereby, the selector 204 outputs the frame N which is output from the camera 14 and which is to be subjected to image-processing by the image processing circuit (A) 201, to the memory 214. The selector 205 selects the node b. Thereby, the selector 205 outputs the frame n (a) which is subjected to image-processing by the image processing circuit (A) 201 and which is yet to be subjected to image-processing by the image processing circuit (B) 202, to the comparison unit 213. The frame n (a) corresponds to the third-processed data.

The software image processing unit 212 reads the frame N from the memory 214 and performs the image processing (A) on the frame N (STEP S24), and outputs the frame n (b) which has been subjected to software-processing to the memory 215. The image processing (A) performed here corresponds to the software processing performed by the CPU 301. The frame n (b) corresponds to the fourth-processed data.

The comparison unit 213 receives the frame n (a) and the frame n (b) and compares the data of the frame n (a) and the frame n (b), and then outputs the detection signal DS indicating whether or not the frame n (a) and the frame n (b) match each other. When the detection signal DS output from the comparison unit 213 indicates a match, the CPU 13 determines that the image processing circuit (A) 201 is not in failure mode, that is, it is in normal operating condition. On the other hand, when the detection signal DS output from the comparison unit 213 indicates a mismatch, the CPU 13 determines that the image processing circuit (A) 201 is in failure mode.

Next, the image processing for the frame N+1 supplied from the camera 14 will be described. The image processing for the frame N+1 is similar to that for the frame N. The frame N+1 is supplied to the image processing circuit 211 from the camera 14. The image processing circuit 211 performs the hardware processing on the frame N+1 using the image processing circuits (A) 201, (B) 202, and (C) 203, and outputs the frame N+1(a) which has been subjected to hardware-processing to the memory 12.

In a case of determining whether or not the image processing circuit (A) 201 is in failure mode, the selector 204 selects the node a and selector 205 selects the node b. Thereby, the selector 204 outputs the frame N+1 supplied from the camera 14 to the memory 214. The selector 205 outputs the frame n+1 (a) which has been subjected to hardware-processing by the image processing circuit (A) 201 to the comparison unit 213.

The software image processing unit 212 performs the image processing (A) on the frame N+1 (STEP S24), and outputs the frame n+1 (b) which has been subjected to software-processing to the memory 215.

The comparison unit 213 compares the frame n+1(a) and the frame n+1(b), and outputs the detection signal DS indicating whether or not the frame n+1(a) and the frame n+1(b) match each other. When the detection signal DS output from the comparison unit 213 indicates a match, the CPU 13 determines that the image processing circuit (A) 201 is not in failure mode, that is, in a normal operating condition. On the other hand, when the detection signal DS output from the comparison unit 213 indicates a mismatch, the CPU 13 determines that the image processing circuit (A) 201 is in failure mode.

Next, the image processing for the frame N+2 supplied from the camera 14 will be described. The image processing for the frame N+2 is similar to that for the frame N or the frame N+1. Here, a case where the failure mode in the image processing circuit (A) 201 is detected in the image processing for the frame N+2 is described.

The frame N+2 is supplied to the image processing circuit 211 from the camera 14. The image processing circuit 211 performs the hardware processing on the frame N+2 using the image processing circuit (A) 201, (B) 202, and (C) 203, and outputs the frame N+2(a) which has been subjected to hardware-processing to the memory 12.

In a case of detecting whether or not the image processing circuit (A) 201 is in failure, the selector 204 selects the node a and the selector 205 selects the node b. Thereby, the selector 204 outputs the frame N+2 supplied from the camera 14 to the memory 214. The selector 205 outputs the frame n+2 (a) which has been subjected to hardware-processing by the image processing circuit (A) 201 to the comparison unit 213.

The software image processing unit 212 performs the image processing (A) on the frame N+2 (STEP S24), and outputs the frame n+2 (b) which has been subjected to software-processing to the memory 215.

The comparison unit 213 compares the frame n+2(a) and the frame n+2(b), and outputs the detection signal DS indicating whether or not the frame n+2(a) and the frame n+2 (b) match with each other. Here, since the detection signal DS output from the comparison unit 213 indicates a mismatch, the CPU 13 determines that the image processing circuit (A) 201 is in failure mode.

In the example described above, a case of detecting the failure mode in the image processing circuit (A) 201 in the image processing circuit 211 is described. However, the detection is similar to the cases of detecting one or a plurality of failures in any of the image processing circuits (A) 201, (B) 202, and (C) 203.

### 3-3. Effects of the Third Embodiment

In the third embodiment, a failure detection target circuit is selected from the individual image processing circuits (A), (B), and (C) in the image processing circuit 211. Then, the detection of failure of an individual image processing circuit can be performed, rather than detecting the failure in all of the image processing circuit 211. Since a targeted image processing circuit in the image processing circuit 211 can be selected for failure detection, only the targeted image processing circuit is inspected, and the inspection is highly efficient. Thereby, it is possible to reduce the time required for the failure detection.

Furthermore, like the first embodiment described above, the fourth-processed data which is compared with the third-processed data output from the image processing circuit 211 can be generated by the software image processing unit 212. Therefore, it is possible to decrease the size of the circuit, the power consumption, and the failure rate, as compared to the case of providing an image processing circuit similar to the image processing circuit 211 to create comparison data for comparison. Other configurations and the effects are similar to those in the first embodiment.

### 4. Fourth Embodiment

A semiconductor device including an image processing device according to a fourth embodiment will be described. In the fourth embodiment, a portion of data among the image data of one frame is compared, and it is determined whether or not the image processing circuit 211 is in failure mode. The configuration of the image processing device 21 is similar to that according to the third embodiment. Hereinafter, in the fourth embodiment, points different from those in the third embodiment will mainly be described.

### 4-1. Operation of the Image Processing Device

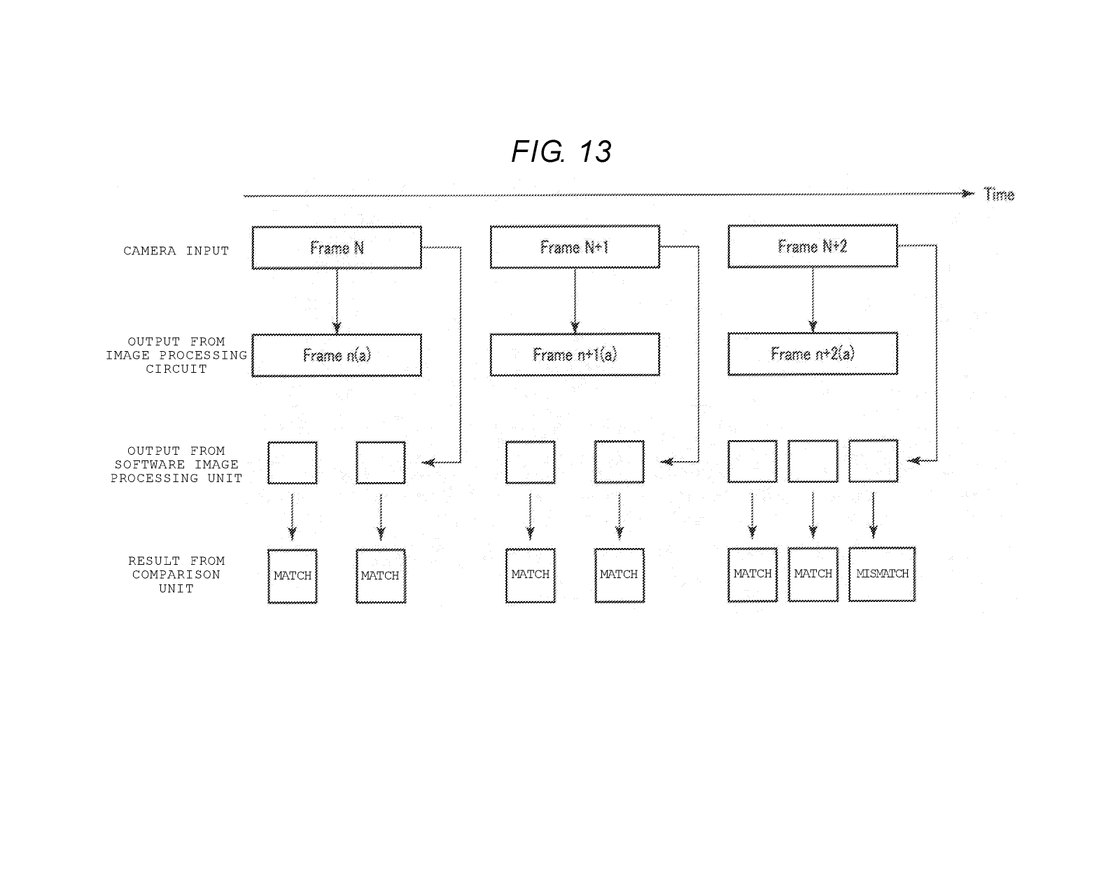

FIG. 13 is a timing chart illustrating an operation of the image processing device according to the fourth embodiment. A case of detecting the failure mode in the image processing circuit (A) 201 in the image processing circuit 211 will be described as an example.

First, the image processing for the frame N will be described. The frame N is supplied to the image processing circuit 211 from the camera 14. The image processing circuit 211 receives the frame N and performs the hardware processing on the frame N using the image processing circuits (A) 201, (B) 202, and (C) 203, and outputs the frame N(a) which has been subjected to hardware-processing to the memory 12.

In a case of detecting whether or not the image processing circuit (A) 201 is in failure mode, the selector 204 selects the node a. Thereby, the selector 204 outputs the frame N which is output from the camera 14 and which is to be subjected to hardware-processing by the image processing circuit (A) 201, to the memory 214. The selector 205 selects the node b. Thereby, the selector 205 outputs the frame n (a) which is subjected to hardware-processing by the image processing circuit (A) 201 and which is to be subjected to hardware-processing by the image processing circuit (B) 202, to the comparison unit 213.

The software image processing unit 212 receives a portion of the data among the image data of the frame N read from the memory 214. The software image processing unit 212 performs the image processing (A) on the received portion of data, and outputs the portion of data which has been subjected to software-processing to the memory 215. The portion of data is, for example, a line of data, a plurality of lines of data, or a specific portion of data in a line among the image data items in the frame N.

The comparison unit 213 compares the portion of data in the frame N(a) output from the image processing circuit 211 and the portion of data which has been subjected to software-processing output from the memory 215. The comparison unit 213 outputs a detection signal DS indicating whether or not the portion of data in the frame N(a) and the portion of data which has been subjected to software-processing match each other. The portion of data from the image processing circuit 211 and the portion of data from the software image processing unit 212 that are compared with each other in the comparison unit 213 are data items corresponding to each other, for example, they are the data items in the same line in the frame N or the data items in the same part of the same line.

When the detection signal DS output from the comparison unit 213 indicates a match, the CPU 13 determines that the image processing circuit 211 is not in failure mode, that is, it is in normal operating condition. On the other hand, when the detection signal DS output from the comparison unit 213 indicates the mismatch, the CPU 13 determines that the image processing circuit 211 is in failure mode.

The image processing for the frame N+1 or the frame N+2 is also the same as that for the frame N, and thus, the description thereof will be omitted.

In FIG. 13, in the image processing for the frame N, a case where the comparison result between the portion of data in the frame n (a) and the portion of data from the software image processing unit 212 indicates a match, and thus, the failure mode does not occur, is described. In the image processing for the frame N+1, a case where the comparison result between the portion of data in the frame n+1(a) and the portion of data from the software image processing unit 212 indicates a match, and thus, the failure mode does not occur, is described and shown. In the image processing for the frame N+2, a case where the comparison result between the portion of data in the frame n+2(a) and the portion of data from the software image processing unit 212 indicates a mismatch, and thus the failure mode has occurred, is shown.

### 4-2. Effects of the Fourth Embodiment

In the fourth embodiment, the software image processing unit 212 performs the image processing on a portion of the data among the image data items in the frame N held in the memory 214. The comparison unit 213 compares the portion of the data which has been subjected to image-processing by the software image processing unit 212 and a corresponding portion of the data in the frame N which has been subjected to image-processing in the image processing circuit 211. The two portions of data items compared in the comparison unit 213 are the data items of portions corresponding to each other among the image data items in the frame N. The CPU 13 determines whether or not the image processing circuit 211 is in failure mode based on the comparison result in the comparison unit 213.

Thereby, by making a portion of the data among the image data items in the frame N as the comparison target, it is possible to reduce the time required for the image processing by the software image processing unit 212 and the time required for the comparison in the comparison unit 213. Furthermore, since the time required for image processing performed by the software image processing unit 212 can be reduced, it is possible that the CPU 13 performs the image processing by the software image processing unit 212 using operational free time in the CPU 13.

As described above, according to the fourth embodiment, by making a portion of the data among the image data items in the frame as the comparison target, it is possible to reduce the time required for the image processing in the software image processing unit 212. Furthermore, it is possible to reduce the load to the CPU 301 (the processor) used for the software processing in the software image processing unit 212. Other configurations and effects are similar to those in the third embodiment.

### 5. Others

The semiconductor device in the embodiments described above can be mounted on various camera-mounting products provided with an image processing device that performs the image data processing. For example, the semiconductor device can be mounted on a digital camera, a digital video camera, a camera for a smart phone, a vehicle mounted camera, and a monitor camera.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A semiconductor device for processing image data of an image, comprising:
an image processing circuit comprising circuit elements configured to process the image data and output first image data;
a processor configured to process the image data using arithmetic processing software and output second image data; and
a comparison unit configured to compare the first image data and the second image data and output a detection signal indicating whether or not the first image data and the second image data match each other.

2. The semiconductor device according to claim 1, further comprising:
a control circuit configured to control the image processing circuit and the comparison unit,
wherein the control circuit comprises the processor.

3. The semiconductor device according to claim 2,
wherein the control circuit further comprises the comparison circuit, and is configured to perform the comparison between the first image data and the second image data of the comparison unit using the arithmetic processing software.

4. The semiconductor device according to claim 1, further comprising:
a first memory storing the arithmetic processing software; and
a second memory storing the second image data which is arithmetically processed using the arithmetic processing software.

5. The semiconductor device according to claim 1,
wherein the image processing circuit comprises a first processing circuit and a second processing circuit having image processing functions, and wherein the first processing circuit is connected to the second processing circuit to supply the output of the first processing circuit to the second processing circuit, and
wherein the image processing circuit further comprises:
a first node at an input portion of the first processing circuit, a second node between the first processing circuit and the second processing circuit, a third node at an output portion of the second processing circuit, and a first selector configured to select the first node or the second node and connect the selected node to the processor, and
a second selector configured to select one of the second node or the third node and connect the selected node to the comparison unit.

6. The semiconductor device according to claim 1,
wherein the image processing circuit includes a first processing circuit and a second processing circuit having image processing functions, wherein the first processing circuit is connected to the second processing circuit to provide the data output from the first processing circuit to the second processing circuit, and
wherein the image processing circuit further comprises:
a first selector configured to select one of the data supplied to the first processing circuit or the data output from the first processing circuit, and supply the selected data to the processor, and
a second selector configured to select one of the data of the data output from the first processing circuit or the data output from the second processing circuit, and supply the selected data to the comparison unit,
wherein, when the first selector supplies the data supplied to the first processing circuit to the processor, the second selector supplies one of the data output from the first processing circuit or the data output from the second processing circuit to the comparison unit, and
wherein, when the first selector supplies the data output from the first processing circuit to the processor, the second selector supplies the data output from the second processing circuit to the comparison unit.

7. The semiconductor device according to claim 6,
wherein the processor performs the image processing on one of the data supplied to the first processing circuit or the data output from the first processing circuit and outputs a portion thereof as the second image data, and
wherein the comparison unit compares the second image data output from the processor and a corresponding portion of the data output from the first processing circuit or the data output from the second processing circuit.

8. The semiconductor device according to claim 1,
wherein the processor is configured to perform image processing on a portion of the image data and output the resulting second image data, and
wherein the comparison unit compares the second image data output from the processor and a corresponding portion of the first image data output from the image processing circuit.

9. The semiconductor device according to claim 8,
wherein the portion of the image data and the corresponding portion of the first image data output from the image processing circuit are at least one line in an image frame.

10. The semiconductor device according to claim 1,
wherein the first image data and the second image data are an individual image frame or lines in the individual image frame.

11. The semiconductor device according to claim 1,
wherein the comparison unit compares the first image data and the second image data using the circuit elements.

12. A method of processing image data of an image, comprising:
receiving the image data corresponding to the image;
processing at least a portion of the image data using circuits to create first data;
processing at least a portion of the image data using a processor with image processing software to create second data;
comparing the first data and the second data; and
providing a comparison output.

13. The method of claim 12, wherein the comparison output is one of the first and second data match or the first and second data mismatch; and
when the comparison output is mismatch, finding that one or more circuits of the circuits used to create the first data image have failed.

14. The method of claim 12, further comprising:
configuring the circuits used to create the first data to include a first circuit and a second circuit connected in series, wherein the first circuit and second circuit perform image processes on the image data;
providing the image data to the first circuit at an input thereto, processing the image data therein, outputting the processed image data to the second circuit, processing the image data therein, and outputting the processed image data therefrom;
using the output of the first circuit as the first data; and
finding that the first circuit has failed if the first and second data do not match.

15. The method of claim 14, wherein the first circuit and the second circuit perform different image processing functions.

16. The method of claim 12, wherein:
the circuits used to create the first data image include a first circuit and a second circuit connected in series, wherein the first circuit and second circuit perform image processes on the image data;
providing the image data to the first circuit at an input thereto, processing the image data therein, outputting the processed image data to the second circuit, processing the image data therein, and outputting the processed image data therefrom;
using the output of the second circuit as the first data; and
finding that the second circuit has failed if the first and second data do not match.

17. The method of claim 12, wherein:
the circuits used to create the first data image include at least three circuits connected in series, wherein each of the at least three circuits have an input and an output; and
using the output of only one of the at least three circuits as the first data.

18. An image processing device, comprising;
a first processor configured to receive image data and process the image data using circuits to create a first data output;
a second processor configured to receive image data and process the image data using software to create a second data output;
a comparison circuit configured to receive the first data output and the second data output, compare the first data output and the second data output, and output a comparison result that the first data output and the second data output match, or that the first data output and the second data output do not match.

19. The image processing device according to claim 18, wherein the first processor comprises the comparison circuit.

20. The device according to claim 18, further comprising a controller configured to control the timing of image data received by the first processor and the second processor.
